(19) United States
(12) Patent Application Publication
(10) Pub. No.: US 2021/0287187 A1
(43) Pub. Date: Sep. 16, 2021

(54) IMAGE PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Takuma MUNEHIRO, Kanagawa (JP)

(73) Assignee: FUJIFILM Business Innovation Corp., Tokyo (JP)

(21) Appl. No.: 16/920,747

(22) Filed: Jul. 5, 2020

(30) Foreign Application Priority Data
Mar. 11, 2020 (JP) 2020-042405

(51) Int. Cl. G06Q 20/08; G06K 9/00; H04N 1/00

(52) U.S. Cl. CPC G06Q 20/085; G06K 2209/01; H04N 1/00331; G06K 9/00442

(57) ABSTRACT

An image processing apparatus includes a processor configured to set plural charging destinations for one user, specify, in a case where specific information is included in a target object which is subjected to processing related to a function of the image processing apparatus, the charging destination associated with the specific information, and perform control to notify the specified charging destination of charging information indicating charging.

### CROSS-REFERENCE TO RELATED APPLICATIONS

This application is based on and claims priority under 35 USC 119 from Japanese Patent Application No. 2020-042405 filed Mar. 11, 2020.

### BACKGROUND

### (i) Technical Field

The present invention relates to an image processing apparatus and a non-transitory computer readable medium storing a program.

### (ii) Related Art

In the related art, an image processing apparatus having a function of charging a usage fee generated due to processing has been proposed (for example, refer to JP2018-125574A). An image processing apparatus disclosed in JP2018-125574A has a first platform that can execute a service providing processing for providing a service to be charged and a second platform that can access the first platform. In addition, the image processing apparatus includes a giving section that is realized in the second platform and gives result data, which is data obtained by a partial processing section, to the first platform, a determining section that determines whether or not to charge based on the result data, and a charging section that executes processing of charging in a case where the determining section determines that the result data should be charged.

### SUMMARY

In a case where there are a plurality of charging destinations for one user, it is necessary to perform work of inputting a charging destination for each target object processed by a user when switching between the charging destinations depending on a processed target object.

Aspects of non-limiting embodiments of the present disclosure relate to an image processing apparatus and a non-transitory computer readable medium storing a program that can set, in a case where there are a plurality of charging destinations for one user, a charging destination depending on a processed target object compared to a method in which a user inputs a charging destination for each processed target object.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing apparatus including a processor configured to set a plurality of charging destinations for one user, specify, in a case where specific information is included in a target object which is subjected to processing related to a function of the image processing apparatus, the charging destination associated with the specific information, and perform control to notify the specified charging destination of charging information indicating charging.

### BRIEF DESCRIPTION OF THE DRAWINGS

Exemplary embodiment (s) of the present invention will be described in detail based on the following figures, wherein:

FIG. 1 is a diagram showing an example of a configuration of an image processing system according to an exemplary embodiment of the present invention;

FIG. 2 is a block diagram showing an example of a control system of an image processing apparatus shown in FIG. 1;

FIG. 3 is a diagram showing an example of a charging destination confirmation screen;

FIG. 4 is a diagram showing an example of a charging destination input screen;

FIG. 5 is a block diagram showing an example of a control system of a server device shown in FIG. 1;

FIG. 6 is a diagram showing an example of a charging destination information table;

FIG. 7 is a flowchart showing an example of an operation of the image processing apparatus shown in FIG. 1;

FIG. 8 is a diagram showing an example of a charging destination confirmation screen in a case where there are a plurality of charging destinations;

FIG. 9 is a diagram showing an example of a detail screen;

FIGS. 10A and 10B are diagrams showing an example of a detail screen according to a modification example; and

FIG. 11 is a diagram showing an example of an association information table.

### DETAILED DESCRIPTION

Hereinafter, an exemplary embodiment of the present invention will be described with reference to the drawings. In each of the drawings, components having substantially the identical function will be assigned with the identical reference signs, and redundant description thereof will be omitted.

### Exemplary Embodiment

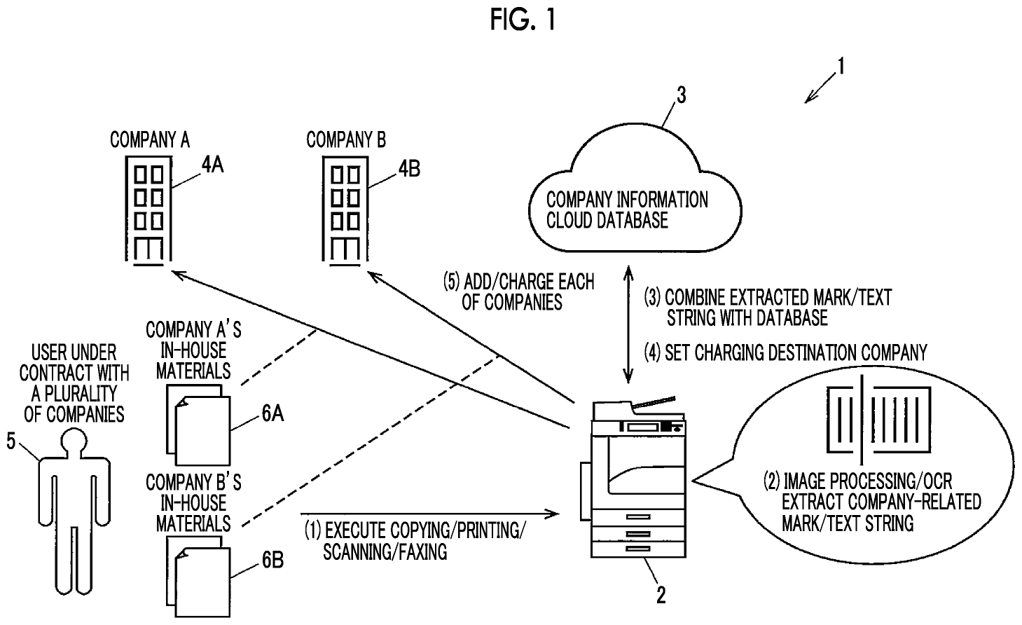

FIG. 1 is a diagram showing an example of a configuration of an image processing system according to the exemplary embodiment of the present invention. This image processing system 1 is configured to include an image processing apparatus 2 and a server device 3. In addition, the image processing apparatus 2 is connected to the server device 3 so as to be able to communicate, and is connected to companies 4A and 4B (referred to as a “company A” and a “company B” in FIG. 1), which are external organizations, so as to be able to communicate.

The image processing apparatus 2, for example, corresponds to a multifunction printer having a plurality of functions such as a function of duplicating, a function of printing, a function of reading, a function of facsimiling, and a function of transmitting electronic mail. The image processing apparatus 2 is not limited to the multifunction printer. The image processing apparatus 2 is an example of the image processing apparatus. Details of a configuration of the image processing apparatus 2 will be described later.

The server device 3 is, for example, a digital front end (DFE) device, and herein, a cloud server device provided on the cloud is used. Details of a configuration of the server device 3 will be described later.

The companies 4A and 4B are external organizations that have contracts with a user (hereinafter, also referred to as a “user”) 5 for performing work. The user 5 uses the image processing apparatus 2 to process materials 6A and 6B (herein, also referred to as “company A's in-house materials” and “company B's in-house materials”) that are used in a case of carrying out some business with the plurality of companies 4A and 4B under contract. The materials 6A and 6B include, for example, printed materials and transmitted materials. The materials 6A and 6B are examples of “target objects which are subjected to processing”.

Herein, the term “processing” includes executing duplication (hereinafter, also referred to as “copying”), printing (hereinafter, also referred to as “printing”), reading (hereinafter, also referred to as “scanning”), and facsimile (hereinafter, also referred to as “faxing”). In addition, each of the companies 4A and 4B is charged for each executed processing.

Hereinafter, flow of charging performed by the image processing system 1 will be summarized below.

(1) The image processing apparatus 2 executes various types of processing related to the functions described above of the image processing apparatus 2 including copying, printing, scanning, and faxing in response to operation by the user 5. In a case of executing processing related to the functions, the image processing apparatus 2 acquires an image of a target object.

(2) The image processing apparatus 2 executes image processing such as optical character recognition (OCR) onto the acquired image, and extracts a company-related mark (details will be described later) and a company-related text string (details will be described later) which are included in the acquired image. That is, the image processing apparatus 2 includes an image processing unit. The schematic diagram shown in a balloon symbol in FIG. 1 schematically shows a state during the execution of scanning.

(3) The image processing apparatus 2 combines the extracted mark and the extracted text string with database (refer to a charging destination information table 311 of FIG.

6) .

(4) The image processing apparatus 2 sets a company (hereinafter, also referred to as a “charging destination company”) that is an execution destination for charging.

(5) The image processing apparatus 2 add information on the processing executed by the user 5 for each of the companies 4A and 4B set as a charging destination, and charges each of the companies 4A and 4B for each period determined in advance. Configuration of Image Processing Apparatus 2

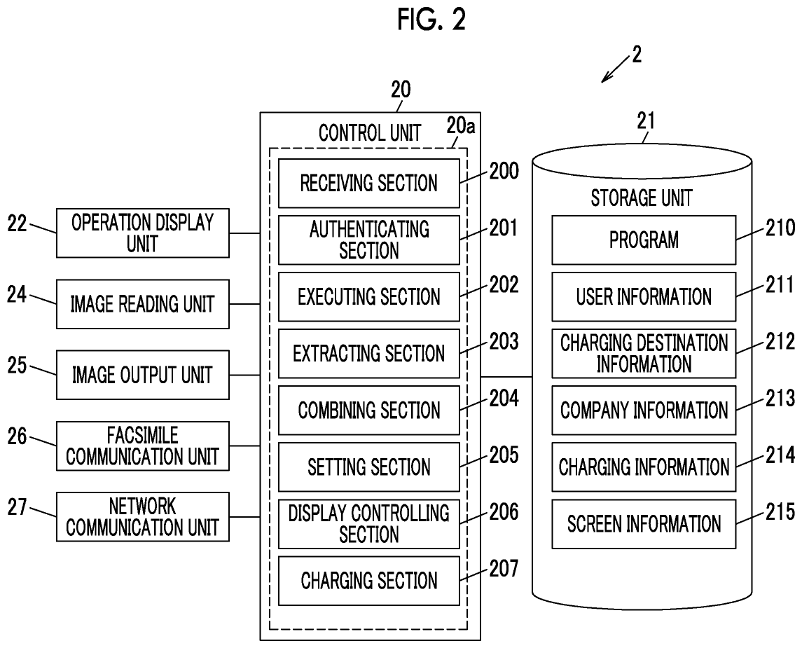

FIG. 2 is a block diagram showing an example of a control system of the image processing apparatus 2. The image processing apparatus 2 includes a control unit 20 that controls each unit, a storage unit 21 that stores various types of data, an operation display unit 22 that inputs and displays information, an image reading unit 24 that reads an image related to a document (hereinafter, also referred to as an “image”) from the document, an image output unit 25 that prints and outputs an image, a facsimile communication unit 26 that transmits and receives a facsimile via a public line network (not shown) to and from an external facsimile device (not shown) , and a network communication unit 27 that communicates with the plurality of companies 4A and 4B under contract with the server device 3 or the user 5.

The control unit 20 is configured by a processor 20a such as a central processing unit (CPU) and an interface. By operating in accordance with a program 210 stored in the storage unit 21, the processor 20a functions as a receiving section 200, an authenticating section 201, an executing section 202, an extracting section 203, a combining section 204, a setting section 205, a display controlling section 206, and a charging section 207. Details of each of the sections 200 to 207 will be described later.

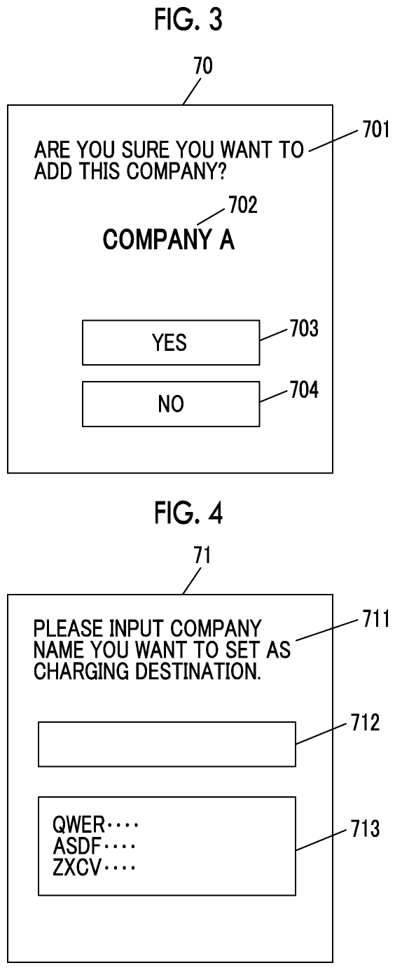

The storage unit 21 is configured by a read only memory (ROM), a random access memory (RAM), and a hard disk, and stores the program 210 and various types of data including user information 211, charging destination information 212, company information 213, charging information 214, and screen information 215 (refer to FIGS. 3, 4, 9, and 10) . In the present specification, the term “store” is used in a case of writing information in the storage unit 21, and the term “record” or the term “register” is used in a case of writing information in various types of information or tables stored in the storage unit 21.

The user information 211 is information for authenticating the user 5, and includes, for example, information for identifying the user, such as a user name and a user ID and information such as a password that is combined in a case of authentication.

The charging destination information 212 is information for identifying a charging destination set as an execution destination for charging. In the charging destination information 212, for example, the names of the companies 4A and 4B set as charging destinations are recorded.

The company information 213 is information indicating the companies 4A and 4B with which the user 5 has a contract, and is configured to include, for example, information for identifying the companies 4A and 4B such as a company name and information for identifying a transmission destination for transmitting information such as an IP address. The company information 213 is provided for each user 5.

The charging information 214 is information in which an amount to be charged (hereinafter, also referred to as an “amount charged”) is recorded. The charging information 214 is, for example, information defined in advance in association with conditions for executing processing such as a type of processing to be executed, including copying, printing, scanning, and faxing, the number of sheets, color information, a single side/double side, and an allocation number.

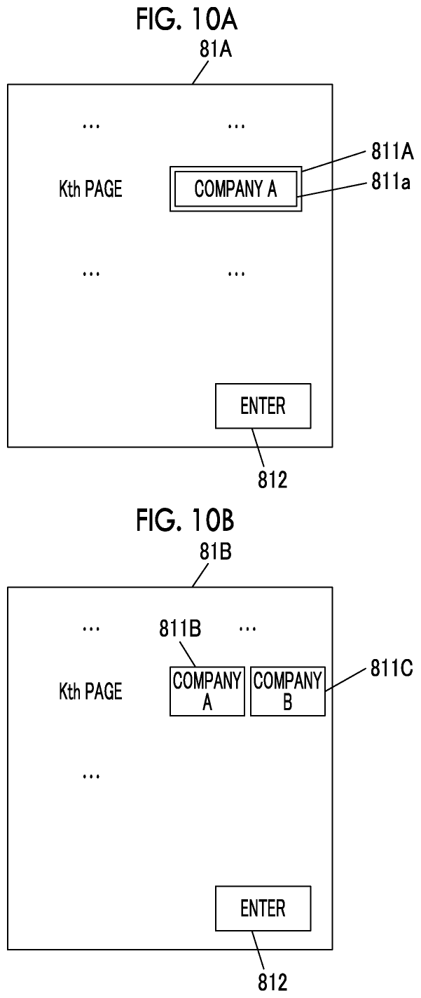

The screen information 215 is information on a screen displayed on the operation display unit 22, and includes, for example, information for configuring a charging destination confirmation screen 70 (refer to FIG. 3), a charging destination input screen 71 (refer to FIG. 4), and detail screens 81, 81A, and 81B (refer to FIGS. 9 and 10). Details of the screens will be described later.

The operation display unit 22 is, for example, a touch panel display, and has a configuration in which a touch panel is disposed in an overlapping manner on a display such as a liquid crystal display.

The image reading unit 24 reads an image from the materials 6A and 6B, which are documents in a paper medium, includes an automatic document feeding device (not shown) provided on a document stand (not shown) and a scanner (not shown), and optically reads the image from the materials 6A and 6B disposed on the document stand or from the materials 6A and 6B fed by the automatic document feeding device.

The image output unit 25 prints and outputs a color image or a monochrome image onto a recording medium such as paper under an electrophotographic method and an inkjet method.

The facsimile communication unit 26 modulates and demodulates data in accordance with facsimile protocols such as G3 and G4, and performs facsimile communication via the public line network.

The network communication unit 27 is realized by a network interface card (NIC), and transmits and receives information or a signal between the plurality of companies 4A and 4B with which the server device 3 and the user 5 have a contract via a network (not shown). Each of Sections 200 to 207

Next, each of the sections 200 to 207 of the control unit 20 will be described. The receiving section 200 receives various types of operation performed on the operation display unit 22.

The authenticating section 201 authenticates the user by combing a user ID and a password, which are input in a case of login, with the user information 211 stored in the storage unit 21.

The executing section 202 controls the image reading unit 24, the image output unit 25, and the facsimile communication unit 26 to execute each processing including copying, printing, scanning, and faxing.

The extracting section 203 executes image processing such as OCR on an image read by the image reading unit 24 to extract text information consists of text or a text string included in the image or graphic information which is stylized by including a symbol, a figure, and text.

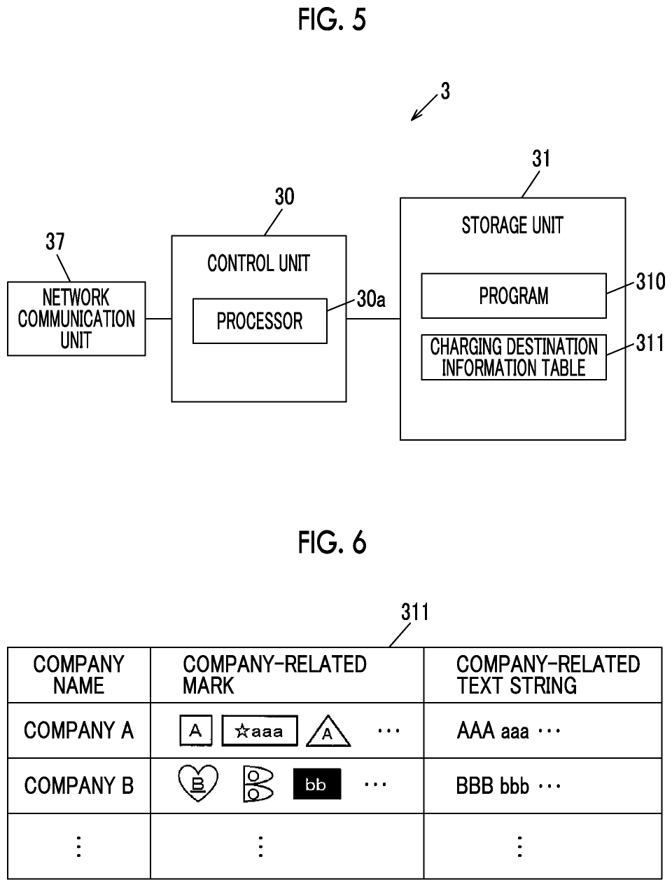

The combining section 204 combines text information or graphic information which is extracted by the extracting section 203 with the charging destination information table 311 (refer to FIGS. 5 and 6) stored in the server device 3, and determines whether or not the extracted text information or the extracted graphic information is included in the “company-related mark” or the “company-related text string” (both will be described later), which is recorded in the charging destination information table 311.

In particular, as for the graphic information, the combining section 204 determines whether or not the extracted graphic information is included in the company-related mark recorded in the charging destination information table 311 by measuring similarity between the graphic information extracted by the extracting section 203 and the company-related mark recorded in the charging destination information table 311, for example, with the use of image processing such as pattern matching.

In other words, the combining section 204 determines whether or not an image acquired by the image reading unit 24 includes the company-related mark or the company-related text string, which is recorded in the charging destination information table 311.

In addition, in a case where the extracted text information or the extracted graphic information is included in the company-related mark or the company-related text string, which is recorded in the charging destination information table 311, the combining section 204 specifies that the companies 4A and 4B associated with the company-related mark or the company-related text string in the charging destination information table 311 as charging destinations.

The combining section 204 may perform the combining by referring to the charging destination information table 311 in the server device 3 via the network, or may perform the combining by controlling the network communication unit 27 and receiving information recorded in the charging destination information table 311 from the server device 3.

In a case where the text information or the graphic information, which is extracted by the extracting section 203, is included in the “company-related mark” or the “company-related text string”, which is recorded in the charging destination information table 311, the setting section 205 sets the corresponding companies 4A and 4B as charging destinations with reference to the charging destination information table 311.

Herein, the term “set” means to confirm. That is, the setting section 205 sets the companies 4A and 4B specified by the combining section 204 as charging destinations. In addition, the setting section 205 records the companies 4A and 4B set as the charging destinations in the charging destination information 212 of the storage unit 21.

Before the charging section 207 to be described later charges, the display controlling section 206 notifies the user 5 of the charging destinations. Specifically, the display controlling section 206 notifies the user 5 of the charging destinations by controlling the operation display unit 22 to display various types of screens recorded in the screen information 215 before charging.

The charging section 207 charges. Specifically, the charging section 207 acquires an IP address of a company recorded in the charging destination information 212 with reference to the company information 213 stored in the storage unit 21, and charges each of the companies 4A and 4B by notifying each company of charging information at the IP address.

Herein, the charging information refers to information related to charging, and is configured to include, for example, an amount charged calculated based on the charging information 214 and a user ID of the user 5 who has instructed to execute the processing.

### Screen

Next, a screen recorded in the screen information 215 will be described with reference to FIGS. 3 and 4.

FIG. 3 is a diagram showing an example of the charging destination confirmation screen 70. The charging destination confirmation screen 70 is a screen for allowing the user to confirm whether or not a charging destination set by the setting section 205 is correct and for instructing charging of the charging destination which is confirmed as correct.

As shown in FIG. 3, the charging destination confirmation screen 70 includes, for example, confirmation guidance information 701 for prompting the user to confirm the charging destination, such as “Are you sure you want to add this company?”, charging destination text information 702 that indicates the set charging destination, an execution button 703 for instructing charging of the charging destination indicated in the charging destination text information 702, and a change button 704 for changing the charging destination.

In addition to the content described above, the charging destination confirmation screen 70 may further display information related to a target object. The information related to a target object corresponds to, for example, an image itself, the title of the target object, information indicating brief description of the content of a document.

FIG. 4 is a diagram showing an example of the charging destination input screen 71. The charging destination input screen 71 is a screen for the user to set a charging destination through manual input. The charging destination input screen 71 may be transitioned and displayed by pressing the change button 704 of the charging destination confirmation screen 70 shown in FIG. 3.

As shown in FIG. 4, the charging destination input screen 71 includes, for example, input guidance information 711 for prompting the user to input a charging destination, such as “Please input a company name you want to set as a charging destination.”, an input field 712 for manually inputting the charging destination, and an operator (for example, a software keyboard) 713 used in inputting the charging destination.

### Configuration of Server Device 3

FIG. 5 is a block diagram showing an example of a control system of the server device 3. As shown in FIG. 5, the server device 3 includes a control unit 30 that controls each unit, a storage unit 31 that stores various types of data, and a network communication unit 37 that communicates with the image processing apparatus 2.

The control unit 30 is configured by a processor 30a such as a central processing unit (CPU) and an interface. The processor 30a operates in accordance with a program 310 stored in the storage unit 31.

The storage unit 31 is configured by a read only memory (ROM) , a random access memory (RAM) , and a hard disk, and stores the program 310 and various types of data including the charging destination information table 311 (refer to FIG. 6).

The network communication unit 37 is realized by a network interface card (NIC) , and transmits and receives information or a signal to and from the image processing apparatus 2 via the network (not shown) .

### Configuration of Table

FIG. 6 is a diagram showing an example of the charging destination information table 311. The charging destination information table 311 is information in which a company-related mark, a company-related text string, and a charging destination are recorded in association with each other. The company-related mark and the company-related text string are examples of specific information. The charging destination information table 311 includes a “company name” field, a “company-related mark” field, and a “company-related text string” field.

In the “company name” field, the names of the companies 4A and 4B registered in advance as organizations that can be charging destinations are recorded. Herein, for example, a text string such as a “company A” and a “company B” are recorded.

In the “company-related mark” field, graphic information related to the companies 4A and 4B (hereinafter, also referred to as a “company-related mark”) is recorded. The company-related mark includes, for example, logo marks of the companies 4A and 4B and figures which are related to products handled or services.

In the “company-related text string”, text strings associated with the companies 4A and 4B (hereinafter, also referred to as “company-related text strings”) are recorded. The company-related text string includes, for example, text strings including the names, abbreviations, common names, and trademarks or some of the described items of the companies 4A and 4B, or text strings related to the names, function names, and services of products handled.

### Operation of Exemplary Embodiment

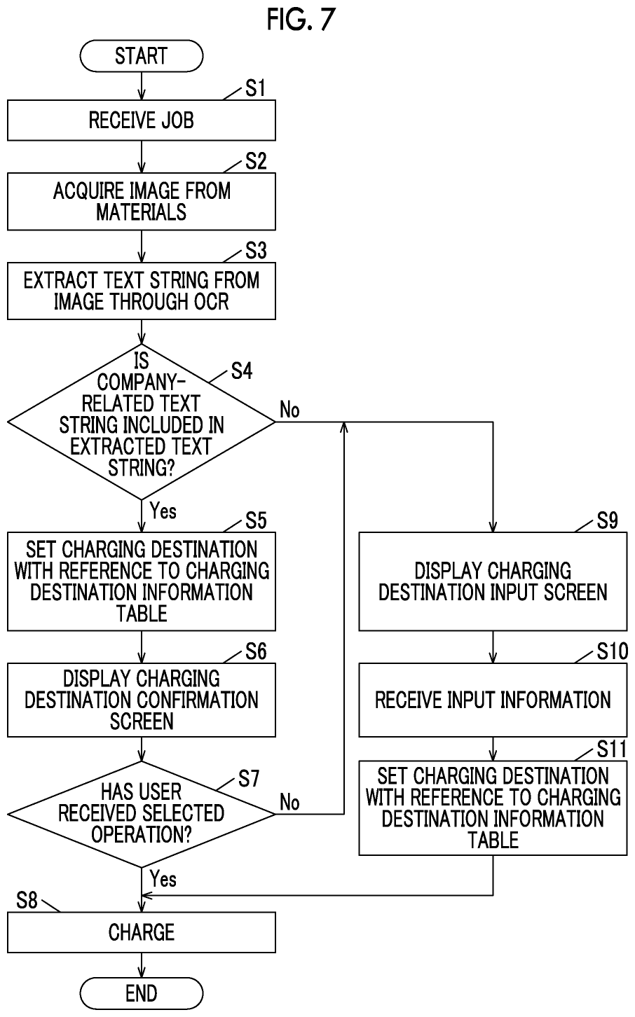

FIG. 7 is a flowchart showing an example of an operation of the image processing apparatus 2 according to the exemplary embodiment. The receiving section 200 receives information for instructing the image processing apparatus 2 to execute processing (hereinafter, also referred to as a “job”). The job includes, for example, information indicating the materials 6A and 6B to be processed (for example, print data), information indicating the type of processing to be executed, and information indicating processing conditions.

The executing section 202 executes processing depending on a job. The executing section 202 acquires an image from the materials 6A and 6B regardless of whether or not a final deliverable is obtained in the processing (S2).

Specifically, in a case of copying, scanning, or faxing, the executing section 202 reads the materials 6A and 6B in a paper medium and acquires an image. In addition, in a case of printing, the executing section 202 acquires printing data related to the materials 6A and 6B as an image.

The extracting section 203 extracts a text string from the image through OCR (S3). The combining section 204 combines the extracted text string with a company-related text string with reference to the charging destination information table 311 stored in the server device 3, and determines whether or not the extracted text string is included in the company-related text string (S4).

In a case where the company-related text string is included in the extracted text string (S4: Yes), the setting section 205 sets a charging destination with reference to the charging destination information table 311 stored in the server device 3 (S5). Specifically, the setting section 205 sets the companies 4A and 4B corresponding to the company-related text string as charging destinations.

The display controlling section 206 controls the operation display unit 22 to display the charging destination confirmation screen 70 shown in FIG. 3 (S6). The receiving section 200 receives operation selected on the charging destination confirmation screen 70 by the user 5 (S7).

In a case where the receiving section 200 receives operation on the execution button 703 (S7: “Yes”), the charging section 207 charges (S8). Specifically, the charging section 207 notifies the companies 4A and 4B which are set as the charging destinations of charging information including an amount charged and user information.

In a case where the company-related text string is not included in the extracted text string (S4: No), the display controlling section 206 controls the operation display unit 22 to display the charging destination input screen 71 shown in FIG. 4 (S9).

The receiving section 200 receives information input in the input field 712 (S10). The setting section 205 sets the companies 4A and 4B indicated in the information input in the input field 712 as charging destinations with reference to the charging destination information table 311 (S11). The charging section 207 charges (S8).

In addition, in a case where the receiving section 200 has not received operation on the change button 704 in Step S7 (S7: “No”), the same operation as Steps S9 to S11 described above is performed.

That is, the display controlling section 206 controls the operation display unit 22 to display the charging destination input screen 71 (S9), the receiving section 200 receives the information input in the input field 712 (S10), the setting section 205 sets the companies 4A and 4B indicated in the information input in the input field 712 as charging destinations with reference to the charging destination information table 311 (S11), and the charging section 207 charges (S8).

Although a case where only text information is extracted by the extracting section 203 is described as an example in the flowchart, the same operation is performed also in a case where graphic information is extracted. That is, the extracting section 203 extracts the graphic information from the image (S3), the combining section 204 determines whether or not the company-related mark is included in the extracted graphic information (S4) , and the setting section 205 sets the companies 4A and 4B corresponding to the company-related mark as charging destinations with reference to the charging destination information table 311 stored in the server device 3 (S5).

In addition, the flow of the operation described above may not be applied only to a case where only one of text information or graphic information is extracted, and may be applied to a case where both of the text information and the graphic information are extracted.

### Case Where There Are Plurality of Charging Destinations

Next, a case where there are a plurality of charging destinations will be described. “A case where there are a plurality of charging destinations” includes, for example, a case where a company-related mark or a company-related text string related to the plurality of companies 4A and 4B is included in the materials 6A and 6B processed by the user 5. In addition, not only a case where the company-related mark or the company-related text string related to the plurality of companies 4A and 4B is included in one page but also a case where the company-related mark or the company-related text string related to the plurality of companies 4A and 4B is included over a plurality of pages is included.

The combining section 204 determines whether or not an image related to one of the materials 6A and 6B includes a plurality of company-related marks or company-related text strings. In a case where the image related to one of the materials 6A and 6B includes the plurality of company-related marks or company-related text strings, the combining section 204 specifies the plurality of companies 4A and 4B corresponding to the plurality of company-related marks or company-related text strings as charging destination candidates.

In a case where the image related to one of the materials 6A and 6B includes the plurality of company-related marks or company-related text strings, the charging section 207 may not notify the charging destinations of charging information.

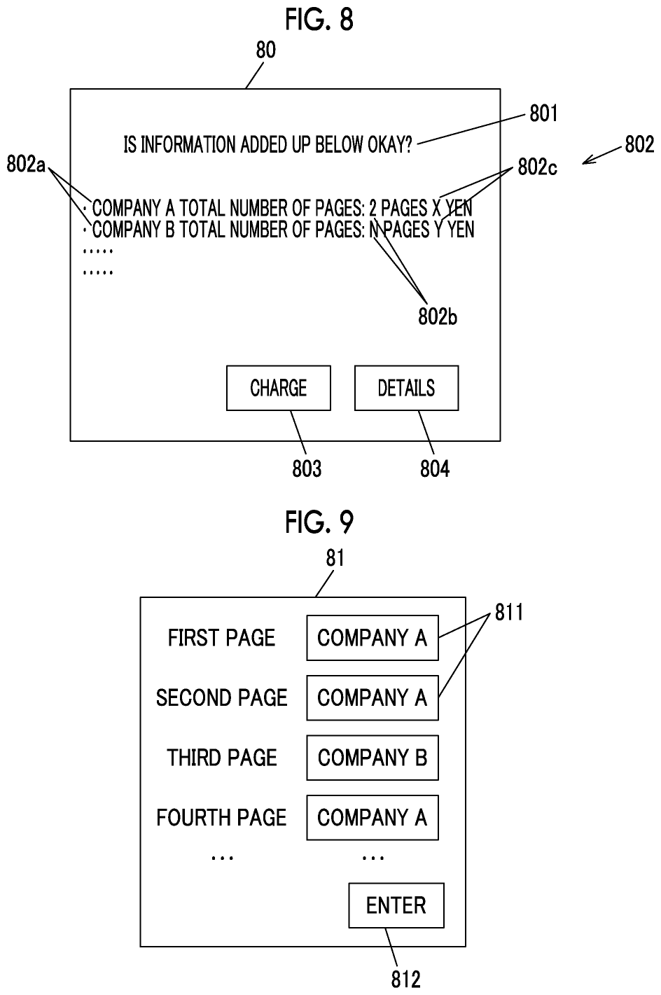

In addition, the display controlling section 206 may notify the user 5 of a list of charging destinations. Specifically, the display controlling section 206 may control the operation display unit 22 to display a second charging destination confirmation screen 80 (refer to FIG. 8) and the detail screens 81, 81A, and 81B (refer to FIGS. 9 and 10).

FIG. 8 is a diagram showing an example of a charging destination confirmation screen in a case where there are a plurality of charging destinations (hereinafter, also referred to as a “second charging destination confirmation screen”. In addition, the charging destination confirmation screen 70 shown in FIG. 3 is also referred to as the “first charging destination confirmation screen 70”). In FIG. 8, a case where information on a plurality of different charging destinations are included in one of the materials 6A and 6B over a plurality of pages will be described as an example.

As shown in FIG. 8, the second charging destination confirmation screen 80 includes, for example, guidance information 801, a list 802 showing charging destination candidates, a setting execution button 803 for setting candidates displayed in the list 802 as charging destinations and instructing charging, and a detail button 804 for displaying the detail screen 81 (refer to FIG. 9) that presents details of the charging destinations displayed in the list 802. In a case where the setting execution button 803 is operated, the setting section 205 sets the candidates as charging destinations, and the charging section 207 charges the candidates.

The list 802 is configured to include, for example, information such as a plurality of company names 802a specified as charging destination candidates, a total number of pages 802b for which each of the companies 4A and 4B is to be charged, and an amount charged 802c. Herein, the amount charged 802c is specified with reference to the charging information 214 stored in the storage unit 21.

For example, the total number of pages 802b may be specified as follows. That is, the extracting section 203 may extract text information or graphic information for each page of the materials 6A and 6B, the combining section 204 may combine the text information and the graphic information with information recorded in the charging destination information table 311 to determine whether or not a company-related mark or a company-related text string is included for each page, and the setting section 205 may calculate the number of pages in which each of the company-related mark or the company-related text string is included according to combining results.

FIG. 9 is a diagram showing an example of the detail screen 81. The detail screen 81 is a screen that displays a list of charging destinations specified as candidates for each page and changes the charging destinations. As described above, the detail screen 81 is transitioned and displayed by pressing the detail button 804 of the second charging destination confirmation screen 80.

As shown in FIG. 9, the detail screen 81 includes, for example, a charging destination button 811 displaying the charging destination candidates specified for each page (a “first page”, a “second page”, . . .) and an enter button 812. The charging destination button 811 indicates charging destinations and can be operated to change the charging destinations.

### Operation in Case Where There Are Plurality of Charging Destinations

Even in a case where there are a plurality of charging destinations, an operation is performed in accordance with the flowchart shown in FIG. 7. In Step S6, the display controlling section 206 controls such that the second charging destination confirmation screen 80 shown in FIG. 8 is displayed instead of the first charging destination confirmation screen 70 shown in FIG. 3.

### MODIFICATION EXAMPLE 1

FIGS. 10A and 10B are diagrams showing the detail screens 81A and 81B according to a modification example. In a case where one page includes a company-related mark or a company-related text string which is related to a plurality of companies, the combining section 204 may detect the plurality of companies as charging destination candidates.

As shown in FIG. 10A, in a case where one charging destination candidate is detected on one page, a charging destination button 811A related to this page may be displayed with an emphasizing display 811a. The emphasizing display 811a may be displayed in a form different from the charging destination button 811 related to another page. For example, a form in which a mark, such as a double frame, a thick line, color, and blinking, is used is applicable.

In addition, as shown in FIG. 10B, in a case where a plurality of charging destination candidates are detected on one page, charging destination buttons 811B and 811C related to the plurality of detected charging destination candidates may be arranged and displayed together.

### MODIFICATION EXAMPLE 2

Although text information or graphic information is extracted as the extracting section 203 executes image processing in the exemplary embodiment described above, the image processing by the extracting section 203 does not necessarily have to be executed. For example, flag information may be used instead of a company-related mark or a company-related text string obtained by the image processing by the extracting section 203. As the flag information, for example, information indicating a charging destination recorded in advance in a header area of image data may be used. The flag information is an example of specific information.

### MODIFICATION EXAMPLE 3

In a case where the materials 6A and 6B identical to the materials 6A and 6B on which image processing has been executed once in the past are processed again, the display controlling section 206 may not notify the user 5 of a charging destination before charging by the charging section 207.

### MODIFICATION EXAMPLE 4

In a case where text information or graphic information, which is extracted by the extracting section 203, is not included in a company-related mark or a company-related text string, which is recorded in the charging destination information table 311, the display controlling section 206 may notify the user 5 of a candidate associated with a charging destination. As an example, the display controlling section 206 may preferentially notify the user 5 of a candidate which is highly associated with the charging destination. For example, whether or not a candidate is “highly associated” may be determined by providing an index indicating an association and determining whether or not the index is equal to or higher than a reference value determined in advance. Hereinafter, specific examples will be shown.

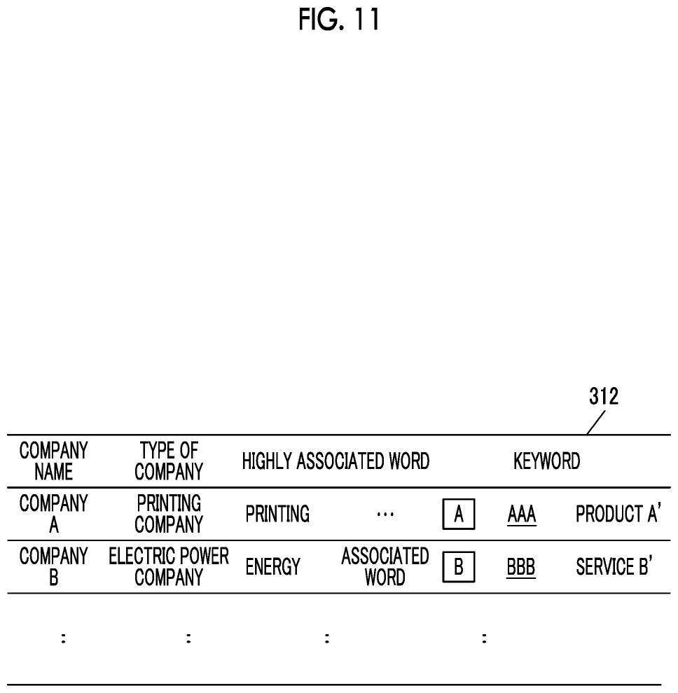

FIG. 11 is a diagram showing an example of an association information table. The association information table 312 is stored in, for example, the storage unit 31 of the server device 3. The association information table may be stored in the storage unit 21 of the image processing apparatus 2.

In the association information table 312, text strings (hereinafter, also referred to as “words”) associated with the companies 4A and 4B registered in the charging destination information table 311 are recorded. The association information table 312 includes, for example, a “company name” field, a “company type” field, a “highly associated word” field, and a “keyword” field.

Information indicating types of the companies 4A and 4B is recorded in the “company type” field. The type of company includes, for example, information indicating what type of field the companies 4A and 4B are in, such as a “printing company” and an “electric power company”.

In the “highly associated word” field, words that are highly associated with the companies 4A and 4B are recorded. The highly associated word includes, for example, a word that indicate the field of business and a word that is the conceptualization of the content of business. In the “keyword” field, for example, words which describe more specific meaning than highly associated words are recorded as words associated with the companies 4A and 4B.

In a case where extracted text information or extracted graphic information is not included in a company-related mark or a company-related text string, which is recorded in the charging destination information table 311, the display controlling section 206 may notify the user 5 of information such as a text string recorded in the “highly associated word” field or the “keyword” field and a figure with reference to the association information table 312.

In addition, the notified information such as the text string and the figure can be selected by the user 5. In this case, the information selected by the user 5 may be newly added to the “company-related mark” field or the “company-related text string” field of the charging destination information table 311.

Although the exemplary embodiment of the present invention has been described hereinbefore, the exemplary embodiment of the present invention is not limited to the exemplary embodiment, and various modifications and execution are possible without departing from the gist of the present invention.

Each section of the processor 20a may be partially or entirely configured by a hardware circuit such as a field programmable gate array (FPGA) and an application specific integrated circuit (ASIC).

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

It is possible to omit or change some of the components of the exemplary embodiment. In the flow of the exemplary embodiment, a step may be added, deleted, changed, and replaced without departing from the gist of the present invention. In addition, a program used in the exemplary embodiment can be provided by being recorded on a computer-readable recording medium such as a CD-ROM, and may be stored in an external server such as a cloud server and be used via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a processor configured to
set a plurality of charging destinations for one user;
specify, in a case where specific information is included in a target object which is subjected to processing related to a function of the image processing apparatus, the charging destination associated with the specific information; and
perform control to notify the specified charging destination of charging information indicating charging.

2. The image processing apparatus according to claim 1, further comprising:
an image processing unit that executes image processing,
wherein the processor is configured to, in a case where the image processing is executed on an image related to the target object and the specific information included in the image is extracted, specify the charging destination associated with the specific information.

3. The image processing apparatus according to claim 2,
wherein the processor is configured to notify the user of information related to the target object and the charging destination before notifying the specified charging destination of the charging information.

4. The image processing apparatus according to claim 3,
wherein the processor is configured to, in a case of executing the function on a target object identical to the target object related to the information of which the user is notified, not notify the user before notifying the charging destination of the charging information.

5. The image processing apparatus according to claim 2,
wherein the processor is configured to, in a case where a plurality of pieces of the specific information are included in the target object, not notify the charging destination of the charging information.

6. The image processing apparatus according to claim 3,
wherein the processor is configured to, in a case where a plurality of pieces of the specific information are included in the target object, not notify the charging destination of the charging information.

7. The image processing apparatus according to claim 4,
wherein the processor is configured to, in a case where a plurality of pieces of the specific information are included in the target object, not notify the charging destination of the charging information.

8. The image processing apparatus according to claim 5,
wherein the processor is configured to notify the user of a list of the plurality of charging destinations associated with a plurality of pieces of the specific information.

9. The image processing apparatus according to claim 6,
wherein the processor is configured to notify the user of a list of the plurality of charging destinations associated with a plurality of pieces of the specific information.

10. The image processing apparatus according to claim 7,
wherein the processor is configured to notify the user of a list of the plurality of charging destinations associated with a plurality of pieces of the specific information.

11. The image processing apparatus according to claim 2,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

12. The image processing apparatus according to claim 3,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

13. The image processing apparatus according to claim 4,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

14. The image processing apparatus according to claim 5,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

15. The image processing apparatus according to claim 6,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

16. The image processing apparatus according to claim 7,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

17. The image processing apparatus according to claim 8,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

18. The image processing apparatus according to claim 9,
wherein the processor is configured to execute optical character recognition for recognizing text on the image, and
the processor is configured to, in a case where the specific information is not included in the image, notify the user of, out of text strings recognized through the optical character recognition, the text string associated with the charging destination.

19. The image processing apparatus according to claim 11,
wherein the processor is configured to, in a case where a specific text string is selected from the text strings of which the user is notified, add the specific text string as the specific information.

20. A non-transitory computer readable medium storing a program causing a processor to:
set a plurality of charging destinations for one user;
specify, in a case where specific information is included in a target object which is subjected to processing related to a function of the non-transitory computer readable medium storing a program, the charging destination associated with the specific information; and
perform control to notify the specified charging destination of charging information indicating charging.
